(19) United States
(12) Patent Application Publication
(10) Pub. No.: US 2004/0039815 A1
(43) Pub. Date: Feb. 26, 2004

(54) Dynamic provisioning system for a network of computers

(75) Inventors: Brady Evans, Bellevue, WA (US); Todd S. Behrbaum, Mercer Island, WA (US); Mark R. Potter, Tomball, TX (US); Thomas L. Buske, Spring, TX (US); John M. Cagle, Houston, TX (US); John M. Hemphill, Spring, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX (US)

(21) Appl. No.: 10/224,217

(22) Filed: Aug. 20, 2002

(51) Int. Cl. G06F 15/16; G06F 15/173

(52) U.S. Cl. 709/225

(57) ABSTRACT

A computer network comprising a plurality of computing entities including a dynamic provisioning system that redeploys computer systems between resource groups. The determination as to when this transition between resource groups should occur is based on performance statistics gathered from the network. The transition from one group to the other includes, disabling the computer from a first resource group, reconfiguring the computer according to a configuration database, and redeploying the reconfigured machine to a second resource group. The second resource group can be an over utilized resource group that needs extra compute resources or it can be an idle resource group.

### CROSS-REFERENCE TO RELATED APPLICATIONS

This disclosure includes subject matter related to U.S. application Ser. No. 09/915,082, incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates generally to active capacity management in a system comprising a plurality of computers. More particularly, the present invention relates to changing the configuration state of one or more computers in the system based on a change in demand for the processing capability of the system or in response to changing capacity or performance of the system or in accordance with criteria specified by a user.

2. Background of the Invention

As is well known, a computer can execute a software application to perform virtually any desired function. As is also known, processing capability can be increased by networking together more than one computer. Each computer in the network then can be assigned one or more tasks to perform. By having a plurality of computers working in concert with each computer performing a portion of the overall set of tasks, the productivity of such a system is much greater than if only one computer was forced to perform the same set of tasks.

It is known that compute resources across a network of interconnected computers may be running different applications, although not always efficiently. For example, one compute resource group within a network of computers may be used as a web server by fetching files requested in conjunction with a web page. Concurrently, another resource group may be configured to provide an application performing complex mathematical operations. These two resource groups have very different, dynamically changing workload characteristics such as peak demand time, network bandwidth or central processing unit (CPU) consumption and average time between transactions to name just a few. As a result, the total resources of the network may not be efficiently allocated, for example the resource group assigned to the web server may be inundated with requests for data, while the other group performing mathematical computations may be sitting idle or under utilized.

Although helpful and typical in deploying applications in a network environment, this type of static configuration methodology may not be the most efficient technique to allocate compute resources in a network of computers as actual workloads vary dynamically. Accordingly, an improvement is needed to dynamically optimize the utilization of individual compute resources in a system of interconnected computers.

### BRIEF SUMMARY OF THE INVENTION

The problems noted above are solved in large part by a dynamic provisioning system that manages the configuration state of a plurality of computing entities that are grouped together by clustering technology. The dynamic provisioning system preferably reconfigures the individual compute resources to utilize the network's total compute resources more efficiently. For example, if a group of computers within the network are assigned to a specific application, say a web server providing news information, then according to a predetermined set of criteria, the web server group may enlist the services of other individual compute resources. The additional resources may come from other application resource groups, or alternately the web server group may take resources from an idle or general resource group. The determination as to when individual resources are reassigned is based on determining certain system metrics for the group of computers assigned to a specific application (e.g., total number of data requests, resource group utilization, and/or average time between data requests or weighted average response time of the application per client). Also, as resource groups are determined to be under utilized, possibly using similar resource group metrics, individual computers within the under utilized group may be transitioned to other groups where need is greater, or alternately to idle or general groups. Once the decision has been made to transition to other resource groups, the system's configuration logic makes this transition in such a way to preferably minimize or at least reduce the performance impact on the system.

In accordance with a preferred embodiment of the invention, the system comprises a plurality of computers with each computer capable of being in one of a plurality of resource groups. The system also includes clustering technology that couples the computers into resource groups and connects resource groups to the network. As incoming transaction requests come in from the network, the clustering technology dynamically routes the requests to one of the computers in order to distribute the load efficiently. If the capacity within the resource group becomes fully utilized or reaches a predetermined threshold, additional computers may be needed. Accordingly, the system also includes automatic provisioning logic that preferably changes the resource group assignment of the plurality of computers based in response to measured system metrics. For example, an individual computer being removed from an under utilized application group as utilization or capacity thresholds or service goals are being met, is preferably reconfigured and redeployed into another resource group requiring more compute capacity. In this case, reconfiguring may include accessing a configuration data-base for particular system configuration settings and assigning these system configuration settings accordingly to change the functionality or personality of the computing device or resource.

These and other advantages will become apparent upon reviewing the following description in relation to the accompanying drawings.

### BRIEF DESCRIPTION OF THE DRAWINGS

For a detailed description of the preferred embodiments of the invention, reference will now be made to the accompanying drawings in which:

FIG. 1 shows a block diagram of a preferred embodiment of a system of computers including clustering technology and configuration logic; and

FIG. 2 shows a flowchart for dynamically provisioning the system of FIG. 1.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. The term “transaction processing computer” (TPC) refers to a computer or other type of computing entity that performs one or more tasks. A TPC, for example, may respond to a request for a web page, perform a numerical calculation, or any other action. The term “compute resource(s)” should also be understood to be equivalent to a TPC(s). The term “dynamic provisioning” refers to the act of measuring certain metrics associated with a group of compute resources and adding or subtracting compute resources. The term “clustering technology” refers any technology that connects computers together to perform a common task. This may include hardware clustering technology (e.g., load balancers) or software clustering technology (e.g., Microsoft Clustering). The term “agent” refers to any computing entity (e.g., another TPC) coupled to the network that is able to request a task or information from a resource group. To the extent that any term is not specially defined in this specification, the intent is that the term is to be given its plain and ordinary meaning.

### DETAILED DESCRIPTION OF THE PREFERRED EMBODIMENTS

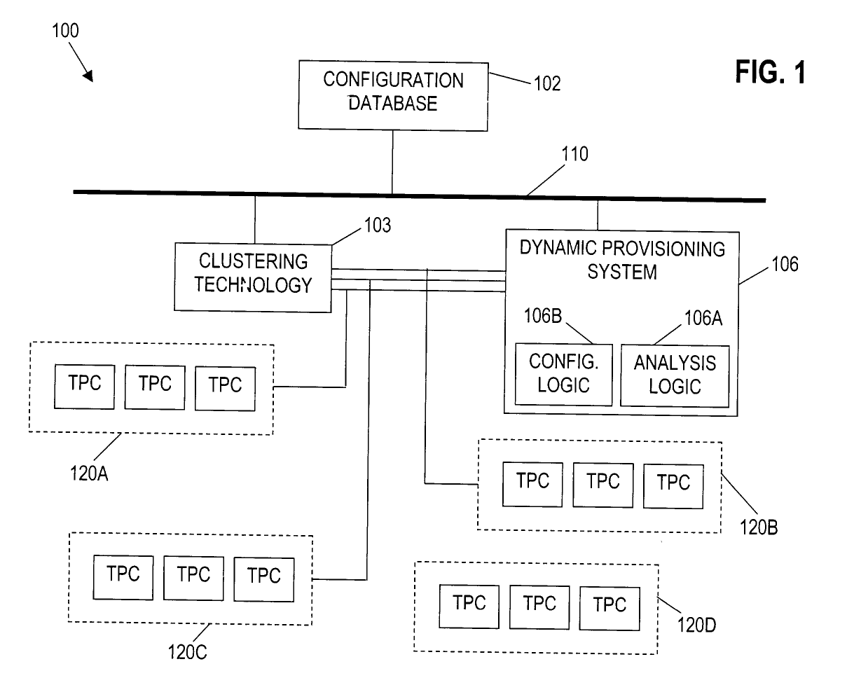

Referring now to FIG. 1, a computer system 100 is shown. Computer system 100 can be set up to perform any desired function. For example, the system could be a “data center” such as for hosting a web site. Further, the TPCs comprising the computer system 100 could be located in the same general area or they could be located in different sites. As shown, Transaction Processing Computers (TPCs) may be grouped into multiple resource groups 120A-120D by a clustering technology 103, in order to provide network applications and services to agents (not shown) across a network 110. Therefore clustering technology 103 couples to the network 110 and also couples, preferably via a separate network, to the resource groups 120A-120D and a dynamic provisioning system 106, which is described in detail below. The clustering technology 103 may itself be implemented in the form of software, hardware or both on a computer or it may be in the form of logic implemented in the TPCs.

The TPCs are grouped together by the clustering technology 103 and provide one or more network applications. Indeed, to the network 110, the network applications seem as though they are being serviced by one entity despite the fact that multiple TPCs in different physical locations may actually be performing the desired network application, this is known as “virtualizing an application.” Also, any number of TPCs may exist in each resource group, and each resource group generally performs a function distinct from the other resource groups. For example, one particular resource group may implement a web site, and as such, system 100 would function to host that web site. Concurrently, another resource group that is also under the direction of the clustering technology 103 may be configured to provide an application performing complex mathematical operations. It should be noted that although a single clustering technology 103 and provisioning system 106 are shown connected to network 110 and resource groups 120A-120D, mirror arrangements connected to network 110 Including other clustering technologies, provisioning systems, and resource groups may exist. For example, the system 100 may exist in one physical location while a mirror image of it may exist in another physical location.

In general, the clustering technology 103 receives requests from agents (not shown) on network 110 for system 100 to perform certain tasks. The clustering technology 103 examines each incoming request and decides which of the TPCs in a particular resource group 120 should perform the requested activity. The clustering technology 103 may make this decision in accordance with any of a variety of well-known or custom criteria that permit the computer system 100 to function in an efficient manner. For example, the clustering technology may assign incoming requests within a resource group to the TPC which has been sitting idle the longest. Alternatively, the clustering technology may assign incoming requests within a resource group to the TPC that is the least utilized. Although a single TPC is capable of performing any incoming request, the system 100 functions more efficiently if all TPCs in a resource group are used to perform actions at the same time such that the overall load is distributed evenly among TPCs within the resource group. In this manner, incoming action requests may be dynamically assigned to different TPCs within a resource group based on the current status of the TPCs. Preferably, the decision as to which TPCs should perform the action requested from the network 110 is a function of which TPCs are capable of quick response to requests in general, as well as which TPCs have fewer requests pending to be executed. It should be noted that clustering technology 103 can support multiple resource groups each supporting at least one application or service to agents across network 110.

The determination of whether a resource group needs additional capacity preferably is accomplished using a dynamic provisioning system 106 that is coupled directly to the clustering technology 103 and the resource groups 120A-120D. For example, if all the TPCs within a resource group are fully utilized, over utilized, or have reached a utilization threshold, then the resource group may need extra TPCs. Each resource group can either be connected and actively servicing requests from the network 110, through clustering technology 103, or can be in an idle or general resource group (e.g., 120D) waiting to be deployed into a resource group 120A, 120B, or 120C. Likewise, the dynamic provisioning system 106 can remove TPCs from resource groups and place them into the idle resource group until they are needed or move TPC resources into other active groups. Network 110 may represent any suitable type of network available to system 100 for receiving transactions, such as the Internet or any local or wide area networks. Each of the TPCs preferably are implemented as computers (e.g., servers) that execute off-the-shelf or custom software. A configuration database 102, that is coupled to network 110, includes settings that may be copied to or “imaged” onto the TPCs prior to assigning them to a resource group.

The dynamic provisioning system 106 balances compute needs across resource groups in the system 100, and to this end, the dynamic provisioning system 106 adds TPCs to resource groups requiring more compute capacity. In addition, the dynamic provisioning system 106 removes TPCs from under utilized resource groups and re-deploys them to resource groups requiring more compute capacity.

Referring still to FIG. 1, the dynamic provisioning system includes configuration logic 106A. The configuration logic 106A configures TPCs for inclusion in the resource group under the direction of the dynamic provisioning system 106. The configuration logic 106A uses the configuration database 102 accessed either locally or remotely via network 110. Configuration database 102 preferably contains configuration information that enables the automatic configuration logic 106A to configure a TPCs hardware, operating system, and application for participation in each resource group under the dynamic provisioning system's control.

The dynamic provisioning system also includes analysis logic 106B. Analysis logic 106B monitors and analyzes one or more aspects or parameters associated with system 100 to determine the ongoing percentage of maximum capacity of each resource group 120. It should be noted that the analysis logic can collect and analyze parameters provided by TPCs to properly characterize the current percentage of maximum capacity utilization of the resource groups. At any moment, the analysis logic can report the current percentage utilization to the dynamic provisioning system 106, so that among other things, a threshold comparison and possible redeployment of TPCs among the resource groups may be made.

In the event that one of the resource groups 120A, 120B, or 120B has excess resource capacity (i.e., under utilized) with respect to its processing demands, the dynamic provisioning system 106, then communicates with the clustering technology 103 of the particular resource group to disable TPCs from that particular resource group. It should be noted that the dynamic provisioning system 106 communicates with all system components needed to properly disable the TPC from a resource group, which may include clustering technology 103. With the TPC disabled, application requests are stopped from being sent to the TPC. The disabled TPC is then reconfigured, where reconfiguring preferably includes reconfiguring the operating system, applications, and/or hardware according to the configuration database 102. Then the newly reconfigured TPC would be available to be deployed into a resource group with inadequate resources (i.e., over utilized), or into an idle resource group.

Preferably the configuration database 102 contains information necessary to make reconfiguration as simplified as possible when transitioning TPCs between resource groups. For example, if a web server resource named group A is over utilized and requires additional compute capacity, the dynamic provisioning system will interact with the configuration database to intelligently determine the best candidate TPC(s) to reconfigure and add resource group A, which lacks capacity. In this scenario, it is plausible that two or more resource groups are under utilized and could allow a TPC to be removed from them and still meet capacity and performance goals. The system would consider how similarly configured the candidate TPCs are to the desired targeted resource group as well as location related information and amount of compute capacity in each candidate TPC to determine the “best-matched” TPC for the resource group. Some of the specific measures that could be analyzed for “best match” would be server configuration or personality and ease of reconfiguring to the targeted configuration or personality (i.e., Linux based web server, Unix based application server, or Microsoft Windows® based server), location as compared to target resource group (i.e., in the same rack, in the same row of racks, in the same domain, in the same data center, etc.), or capacity related information (i.e., size and quantity of networking interface card(s) (10/100/1000B), quantity and speed or CPU(s), quantity, type and speed of disk drives, etc.). The utilization statistics may be stored in the configuration database 102 or alternately some other database coupled to the network 110 and accessed by the analysis logic 106. In addition, if for example the TPC is coming from a system that executes complex mathematical computation, then prior to being redeployed into the web server application, this system may need to have a new operating system as well as other applications installed. Accordingly, the configuration database 102 may store what resources (both hardware and software) are necessary for each resource group, as well as the actual resources themselves.

In the event that the dynamic provisioning system identifies a resource group to be over utilized, the dynamic provisioning system then uses the aforementioned configuration database 102 to reconfigure the disabled TPC in preparation for deployment into the over utilized group. The dynamic provisioning system 106 then communicates with the cluster technology associated with the target resource group, which may be the same cluster technology as the TPC's destination resource group or may be another cluster technology connected through network 110. Thus, by adding the new TPC to the over utilized resource group, more capacity is provided and the total compute resources are optimized. It should also be understood, however, that a TPC can be removed from one resource group and moved to another resource group even if the latter group is not currently over utilized.

The dynamic provisioning system may utilize idle resource group 120D (which may or may not contain systems that need to be configured), to service needs for additional capacity in situations where there are no other systems available from other resource groups. Idle resource group 120D, contains unconfigured systems.

The dynamic provisioning system may provide various levels of functionality, including collecting and recording performance statistics from compute nodes and resource groups. The collected statistics may be hardware statistics (CPU speed, amount of memory available, etc.) or they may be software statistics (OS version, programs currently running, etc.). These statistics may then be analyzed so that TPCs may be provisioned to run the appropriate application to optimize utilization of all TPCs within a business enterprise's compute resources. The dynamic provisioning system may also have the capability to characterize the capacity of each of the TPCs or compute resources so as to build a capacity based ranking or hierarchy of the resources. This ranking or hierarchy would assist in the prioritization of provisioning actions. For example, the lowest ranking server may be removed if workload is decreasing and capacity is much greater than the required compute capacity. Conversely, the highest ranking server (greatest capacity) may be added if workload is drastically increasing the required capacity of the pool or group. The dynamic provisioning system may provision resources according to four different methods: baseline, real-time, scheduled, and event based.

In the baseline method of provisioning resources, the dynamic provisioning system stores real-time load data and establishes a baseline with respect to time. The dynamic provisioning system has a record of the maximum compute capacity of every TPC under its control, and also has record of all the resource groups providing different network applications. Using the collected real-time statistics the dynamic provisioning system determines the current load (as a percentage of maximum compute capacity) for a resource group associated with a particular network application. From this a baseline with respect to time is established. The baseline is used to determine at what times the resource group is under utilized and at what times the resource group is over utilized. This utilization data can be used to add compute nodes to resource groups that are over utilized from resource groups that are under utilized and vice versa. In the event that the dynamic provisioning system cannot free up TPCs to add to over utilized resource groups, the dynamic provisioning system allows for an idle resource group where additional TPCs exist that may be used to solve this problem.

The real-time analysis method of dynamic provisioning also measures the current load on resource groups and TPCs performing different network applications. Under the real-time method, the dynamic provisioning system defines thresholds on resource group capacity that, if reached, will cause the dynamic provisioning system to provision new TPCs or remove TPCs from resource groups if the thresholds are reached. For example, assume the maximum capacity for a resource group is 4000 TCP Segments/Sec. Also in this same example, assume the dynamic provisioning system were configured with an “add resource threshold” of 3900 TCP Segments/Sec, and also with a “remove resource threshold” of 3000 TCP Segments/Sec. Under this system, if the current real-time load measurement of the resource group exceeds 3900 TCP Segments/Sec the dynamic provisioning system will add TPCs to the resource group. As described above, the additional TPCs may either come from an existing resource group that is being under utilized, or from an idle resource group. Alternatively in this same system, if the load measurement of the example system drops below 3000 TCP Segments/Sec, TPCs will be removed from the resource group and could then be dynamically provisioned to other resource groups or could be placed into the idle resource group. A hysteresis algorithm could also be added to prevent the dynamic provisioning system from erratically adding and removing TPCs in short durations.

The scheduled dynamic provisioning method allows system administrators the ability to schedule TPC migrations from one resource group to another. For example, a system administrator may wish to schedule additional TPCs to be available to a resource group in anticipation of a higher volume of traffic resulting from web broadcasts, software releases, and/or news events to name but a few.

The event based provisioning method responds to transient conditions that could trigger the dynamic provisioning system to provision a TPC into another resource group or transition a TPC from a resource group and replace it with another TPC. For example, the dynamic provisioning system may monitor (through an external monitoring component), the health of TPCs that exist in resource groups. The health monitoring component may determine when a TPC has or will have reduced capacity due to a catastrophic failure of one of its internal components. Accordingly, the health monitoring component could then notify the dynamic provisioning system, where the dynamic provisioning system takes the steps outlined above to remove the TPC from the resource group and add a new TPC from another resource group or the idle resource group pro actively.

Resources may also be provisioned according to hybrid combinations of the above mentioned methods as would be evident to one of ordinary skill in the art. Although the above mentioned dynamic provisioning methods determine whether computing resources are balanced according to different criteria, each of the three dynamic provisioning methods react similarly.

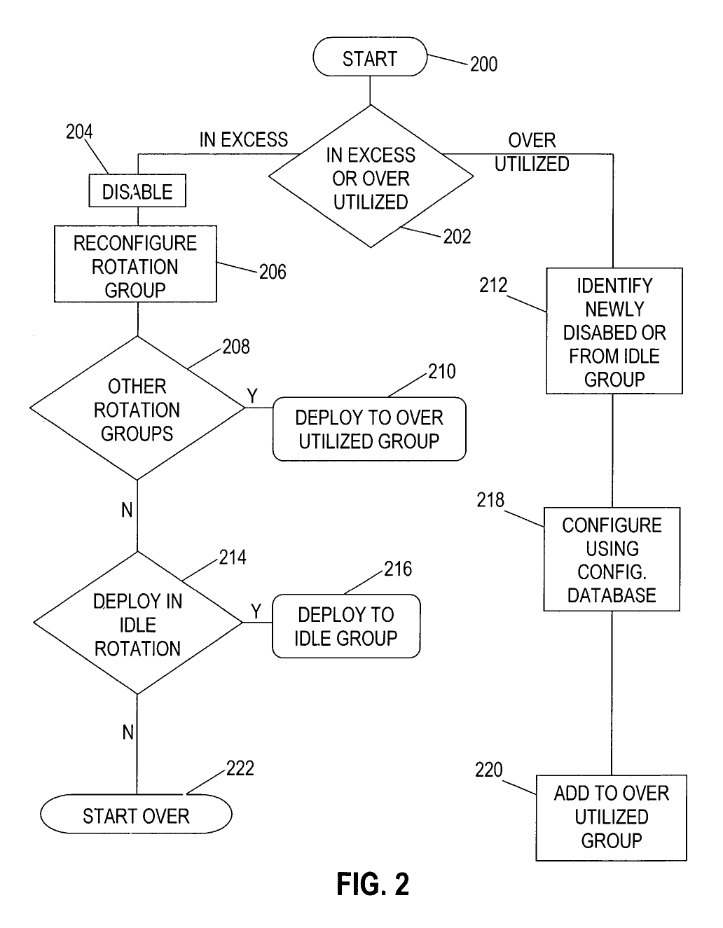

Referring now to FIG. 2, a flowchart depicting the dynamic provisioning process is shown. It should be noted that any of the above mentioned dynamic provisioning methods (i.e., baseline, real-time, scheduled, event based, and/or hybrid) may be used to initiate the process of FIG. 2. The process is performed on a resource group (i.e., 120A-120D) by beginning at START 200. Next the process determines in step 202 whether the resource group is over utilized (needing more TPCs) or in excess (able to donate TPCs) as a result of requests from agents and the subsequent dynamic assignment of tasks to TPCs as described above. If the resource group is in excess then in step 204 a TPC is disabled from the resource group. Then in step 206 the disabled TPC has its resource group settings reconfigured using the configuration database as described above. Next, in step 208 a decision is made as to whether there are other resource groups that are over utilized. If there are other resource groups that are over utilized then the reconfigured TPC is deployed to this over utilized group in step 210. If no other resource groups are over utilized, then in step 214 a decision is made to either redeploy the reconfigured TPC to the idle resource group as seen in step 216, or the process starts over at step 200 as directed by START OVER 222.

If on the other hand the resource group in question is determined from step 202 to be over utilized, then as seen in step 212, available TPCs are identified from either the idle group or as newly disabled. Next in step 218, the available TPC is configured using the configuration database 102. Lastly, in step 220 the configured TPC is added to the over utilized resource group. The process of FIG. 2 is iteratively repeated among resource groups within the system to optimize compute resources.

It should also be understood from this disclosure that both redeploying TPCs and adjusting their configuration states may be performed simultaneously.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system of computers, comprising:
a clustering technology coupled to a plurality of transaction processing computers and a network, wherein said clustering technology assembles the transaction processing computers into resource groups that accomplish a common application; and
a dynamic provisioning system coupled to the plurality of transaction processing computers and the clustering technology;
wherein incoming requests from the network are assigned to transaction processing computers within a resource group by said clustering technology, wherein this assignment within the resource group is based upon transaction processing computer load status;
wherein transaction processing computers may be both added and removed by the dynamic provisioning system from one resource group to another in response to the resource group's load status.

2. The system of computers of claim 1 further comprising a configuration database, wherein said computers are reconfigured according to information from the configuration database prior to being deployed in a new resource group.

3. The system of computers of claim 1 wherein said network comprises an Intranet.

4. The system of computers of claim 1 wherein the addition and removal of transaction processing computers is accomplished by comparing the maximum compute capacity of the compute resources to a baseline with respect to time of real-time load data.

5. The system of computers of claim 1 wherein the addition and removal of transaction processing computers is accomplished by measuring real-time load data and comparing it to predetermined thresholds and capacities.

6. The system of computers of claim 1 wherein the addition and removal of transaction processing computers is scheduled in accordance with anticipated load data.

7. The system of computers of claim 1 wherein the clustering technology collects and records the performance statistics from said computers nodes and resource groups.

8. The system of computers of claim 7, wherein the performance statistics comprise hardware statistics.

9. The system of computers of claim 7, wherein the performance statistics comprise software statistics.

10. The system of computers of claim 1, wherein the dynamic provisioning system disables said computer from a first resource group, reconfigures said computer according to information in a configuration database, and redeploys said computer to a second resource group.

11. The system of computers of claim 10 wherein the dynamic provisioning system uses hysteresis when redeploying said computer.

12. The system of computers of claim 10 wherein the second resource group includes an idle resource group in which the idle resource group includes unassigned compute resources.

13. The system of computers of claim 10 wherein the second resource group includes an over utilized resource group in which the over utilized group is a group of computers performing an application where the compute supply does not meet the compute demand.

14. A method of dynamically assigning incoming network application requests within a computer network, comprising:
receiving incoming network application requests with a clustering technology that assigns the requests to at least one of a plurality of computers within a resource group;
collecting performance statistics regarding the resource group's load and compute capacity; and
determining whether to add or remove computers to the resource group based on the collected statistics.

15. The method of claim 14, wherein the assignment of incoming network requests by said clustering technology to at least one of a plurality of computers maximizes the efficiency of the resource group.

16. The method of claim 14, wherein computers are added to the resource group when the collected statistics indicate that the resource group is over utilized, and said addition of computers includes identifying a “best-fit” computer(s) and reconfiguring said computers using a configuration database prior to said addition.

17. The method of claim 14, wherein computers are added removed from the resource group when the collected statistics indicate that the resource group is under utilized and has excess capacity.

18. The method of claim 14, wherein said added computers come from an idle resource group of unassigned compute resources.

19. The method of claim 14, wherein said removed computers are sent to an idle resource group of unassigned compute resources.

20. A method of dynamically provisioning compute resources within a computer network, comprising:
determining that compute capacity among a plurality of computers configured as a resource group is over utilized by analyzing collected performance statistics;
identifying available compute resources from either a group of newly disabled computers or from a resource group of idle computers;
configuring at least one of the available compute resources using a configuration database; and
adding at least one of the newly configured compute resources to an over utilized group.

21. The computer network of claim 20 wherein the configuration database collects and records the performance statistics from individual compute nodes and resource groups.

22. A data center, comprising:
a clustering technology coupled to a network and a plurality of transaction processing computers;
a dynamic provisioning system coupled to the clustering technology and the plurality of transaction processing computers;
wherein the plurality of transaction processing computers coupled to the clustering technology are arranged as a resource groups, wherein each resource group is assigned an application;
wherein the clustering technology monitors incoming requests from the network and accordingly assigns the incoming requests to transaction processing computers within the appropriate resource group;
wherein transaction processing computers are added and removed from resource groups based on increases and decreases in required compute resources respectively.

23. The data center of claim 22, wherein the clustering technology and the dynamic provisioning system utilize separate networks.

24. The data center of claim 22, wherein the clustering technology is implemented using hardware.

25. The data center of claim 22, wherein the clustering technology is implemented using software.

26. The method according to claim 22, wherein reconfiguring includes changes to the operating system and software applications.

27. The method according to claim 22, wherein reconfiguring includes hardware changes.
